(19) United States
(12) Patent Application Publication
(10) Pub. No.: US 2025/0158922 A1
(43) Pub. Date: May 15, 2025

(54) COMMUNICATION DEVICE, SDN CONTROLLER, AND METHODS THEREIN FOR FACILITATING PATH COMPUTATION

(71) Applicant: Telefonaktiebolaget LM Ericsson (publ), Stockholm (SE)

(72) Inventors: Jiang HE, Beijing (CN); Congjie ZHANG, Beijing (CN); Qiang FU, Beijing (CN)

(21) Appl. No.: 18/838,422

(22) PCT Filed: Feb. 16, 2022
(86) PCT No.: PCT/CN2022/076472

§ 371 Date: Aug. 14, 2024

(51) Int. Cl. H04L 45/00; H04L 45/50; H04L 45/76

(52) U.S. Cl. CPC H04L 45/34; H04L 45/50; H04L 45/76

(57) ABSTRACT

A method in a first communication device. The method includes: advertising, to a second communication device or a Software Defined Networking, SDN, controller, a first Maximum Segment Identifier ‘SID’ Depth, MSD, type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

### TECHNICAL FIELD

The present disclosure relates to communication technology, and more particularly, to a communication device, a Software-Defined Networking (SDN) controller, and methods therein for facilitating path computation.

### BACKGROUND

Segment Routing (SR) Traffic Engineering (TE) Label-Switched Paths (LSPs) can be installed using Software-Defined Networking (SDN) in a form of Path Computation Element (PCE).

When programming or computing an LSP on an SDN controller, it is critical that the controller knows a Maximum Segment Identifier (SID) Depth (MSD) that can be imposed at each node in the LSP, so as to ensure that an SID stack depth at each node in the computed path will not exceed the number of SIDs the node is capable of imposing.

The MSD can be advertised by using Interior Gateway Protocol (IGP) Intermediate System to Intermediate System (ISIS) or Open Shortest Path First (OSPF), Border Gateway Protocol (BGP), or Path Computation Element Protocol (PCEP) from one router to another, and from a router to an SDN controller. For further details, reference can be made to the following documents, each of which is incorporated herein by reference in its entirety:
Internet Engineering Task Force (IETF) Request for Comments (RFC) 8491: Signaling Maximum SID Depth (MSD) Using IS-IS,
draft-ietf-idr-bgp-Is-segment-routing-msd-02: Signaling MSD (Maximum SID Depth) using Border Gateway Protocol Link-State,
draft-ietf-pce-segment-routing-13: PCEP Extensions for Segment Routing,
draft-ietf-Isr-isis-srv6-extensions-18: IS-IS Extensions to Support Segment Routing over IPv6 Data plane.

As described in the above reference documents, one MSD type is defined for each encapsulation and decapsulation in IGP (ISIS or OSPF)/BGP/PCEP.

The MSD is dependent on a hardware capacity of a router. Due to chip pipeline logic/resource bottleneck, a router cannot support unlimited MSD.

Currently, there are two chip solutions in the industry:
1 pass solution: with one pass through a packet processing pipeline, an MSD up to N (e.g., 3) can be supported, and
1+ pass solution: with recirculation (more than one pass) through a packet processing pipeline, an MSD of M (M>N) can be supported, at expense of latency and bandwidth.

A router announces the MSD it supports based on the 1+ pass solution. However, in reality there may be some scenarios where such MSD could be problematic. For example, in a front-haul scenario, a service is sensitive to an end-to-end latency from radio to baseband via one or more routers. For such service, a small MSD based on the 1 pass solution is better than a large MSD based on the 1+ pass solution, and an SDN controller would need to program a small MSD for an ingress node to reduce the latency. On the other hand, for end-end LSP programming, an SDN controller may use an existing solution such as binding segment on an Area Border Router (ABR). In such scenario, the SDN controller needs to communicate with a number of nodes to program the end-to-end LSP, resulting in additional overhead in the network.

The current PCE in the SDN controller can support calculation of the best path based on custom latency, bandwidth, etc., for end-end LSP in the SDN. However, with the current MSD mechanism, the calculated best path may not match the custom latency and/or bandwidth as a node using the 1+ pass solution may have a higher latency and/or lower bandwidth than the node latency and/or bandwidth reported to the SDN controller (as a result of recirculation).

### SUMMARY

It is an object of the present disclosure to provide communication devices and methods therein, capable of solving, or at least mitigating, the above problem.

According to a first aspect of the present disclosure, a method in a first communication device is provided. The method includes: advertising, to a second communication device or an SDN controller, a first MSD type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base Multi-Protocol Label Switching (MPLS) or Segment Routing over Internet Protocol version 6 (IPv6) (SRv6) Imposition MSD.

In an embodiment, the second communication device may be in a same IGP domain as the first communication device, and the first MSD type, the first MSD value, the second MSD type, and the second MSD value may be advertised to the second communication device using an IS-IS or OSPF protocol.

In an embodiment, the first MSD type, the first MSD value, the second MSD type, and the second MSD value may be advertised to the SDN controller using BGP-Link State (BGP-LS) or PCEP.

According to a second aspect of the present disclosure, a first communication device is provided. The first communication device includes a communication interface, a processor and a memory. The memory contains instructions executable by the processor whereby the first communication device is operative to perform the method according to the above first aspect.

According to a third aspect of the present disclosure, a computer-readable storage medium is provided. The computer-readable storage medium has computer-readable instructions stored thereon. The computer-readable instructions, when executed by a processor of a first communication device, configure the first communication device to perform the method according to the above first aspect.

According to a fourth aspect of the present disclosure, a method in a second communication device is provided. The method includes: receiving, from a first communication device, a first MSD, type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base MPLS or SRv6 Imposition MSD.

In an embodiment, the first communication device may be in a same IGP domain as the second communication device, and the first MSD type, the first MSD value, the second MSD type, and the second MSD value may be received using an IS-IS or OSPF protocol.

In an embodiment, the method may further include: advertising the first MSD type, the first MSD value, the second MSD type, and the second MSD value to an SDN controller using BGP-LS or PCEP.

According to a fifth aspect of the present disclosure, a second communication device is provided. The second communication device includes a communication interface, a processor and a memory. The memory contains instructions executable by the processor whereby the second communication device is operative to perform the method according to the above fourth aspect.

According to a sixth aspect of the present disclosure, a computer-readable storage medium is provided. The computer-readable storage medium has computer-readable instructions stored thereon. The computer-readable instructions, when executed by a processor of a second communication device, configure the second communication device to perform the method according to the above fourth aspect.

According to a seventh aspect of the present disclosure, a method in an SDN controller is provided. The method includes: receiving a first MSD type, a first MSD value associated with the first MSD type, a second MSD type, and a second MSD value associated with the second MSD type. The first MSD value indicates a maximum number of SIDs that is supported by a first communication device, and the second MSD value indicates a maximum number of SIDs that can be imposed at the first communication device with one pass through a packet processing pipeline.

In an embodiment, the first MSD type, the first MSD value, the second MSD type, and the second MSD value may be received from the first communication device or a second communication device in a same IGP domain as the first communication device, using BGP-LS or PCEP.

In an embodiment, the method may further include: calculating, for a service, a path including the first communication device based on the first MSD value or the second MSD value.

In an embodiment, the path may be calculated based on the first MSD value when the service is not sensitive to latency and/or bandwidth.

In an embodiment, the path may be calculated based on the second MSD value when the service is sensitive to latency and/or bandwidth.

In an embodiment, the path may be calculated subject to a latency constraint and/or a bandwidth constraint.

In an embodiment, the method may further include: determining, based on the second MSD value, that no path including the first communication device satisfies a latency constraint and/or a bandwidth constraint for a service.

In an embodiment, the method may further include: generating an error report when no path is found to satisfy the latency constraint and/or the bandwidth constraint.

According to an eighth aspect of the present disclosure, an SDN controller is provided. The SDN controller includes a communication interface, a processor and a memory. The memory contains instructions executable by the processor whereby the SDN controller is operative to perform the method according to the seventh aspect.

According to a ninth aspect of the present disclosure, a computer-readable storage medium is provided. The computer-readable storage medium has computer-readable instructions stored thereon. The computer-readable instructions, when executed by a processor of an SDN controller, configure the SDN controller to perform the method according to the above seventh aspect.

With the embodiments of the present disclosure, a new MSD type and accordingly a new MSD value are introduced. The MSD value indicates a maximum number of SIDs that can be imposed at a communication device with one pass through a packet processing pipeline. The MSD value is advertised to e.g., an SDN controller, such that the SDN controller can calculate a path properly to match a required latency and/or bandwidth.

### BRIEF DESCRIPTION OF THE DRAWINGS

The above and other objects, features and advantages will be more apparent from the following description of embodiments with reference to the figures, in which:

FIG. 1 is a flowchart illustrating a method according to an embodiment of the present disclosure;

FIG. 2 is a schematic diagram showing an example of MSD Advertisement according to an embodiment of the present disclosure;

FIG. 3 is a flowchart illustrating a method according to another embodiment of the present disclosure;

FIG. 4 is a flowchart illustrating a method according to yet another embodiment of the present disclosure;

FIG. 5 is a schematic diagram showing an example of LSP programing according to an embodiment of the present disclosure;

FIG. 6 is a block diagram of a first communication device according to an embodiment of the present disclosure;

FIG. 7 is a block diagram of a first communication device according to another embodiment of the present disclosure;

FIG. 8 is a block diagram of a second communication device according to an embodiment of the present disclosure;

FIG. 9 is a block diagram of a second communication device according to another embodiment of the present disclosure;

FIG. 10 is a block diagram of an SDN controller according to an embodiment of the present disclosure; and

FIG. 11 is a block diagram of an SDN controller according to another embodiment of the present disclosure.

### DETAILED DESCRIPTION

As used herein, the term “communication device” refers to any device or node in a wired or wireless communication network. For example, a communication device may be a network device or node, such as an access network node or a core network node. Alternatively, a communication device may be a terminal device, such as a User Equipment (UE), that can access a communication network.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

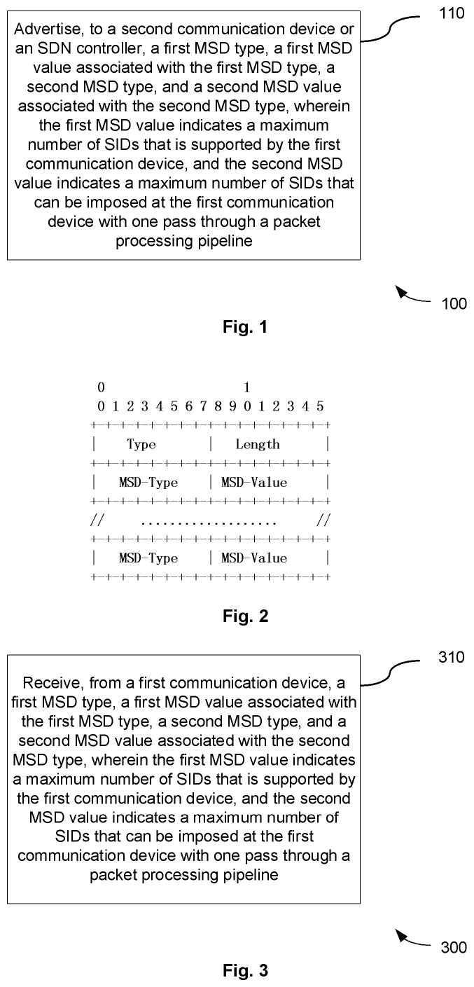

FIG. 1 is a flowchart illustrating a method 100 according to an embodiment of the present disclosure. The method 100 can be performed at a first communication device.

At block 110, the first communication device advertises, to a second communication device or an SDN controller, a first MSD type, a first MSD value associated with the first MSD type, a second MSD type, and a second MSD value associated with the second MSD type. Here, the first MSD value indicates a maximum number of SIDs that is supported by the first communication device (for example, in the 1+ pass solution as described above), and the second MSD value indicates a maximum number of SIDs that can be imposed at the first communication device with one pass through a packet processing pipeline (for example, in the 1 pass solution as described above).

In an example, the first MSD type may be Base MPLS or SRv6 Imposition MSD. The maximum number of SIDs that is supported by the first communication device may refer to a maximum number of SIDs that can be imposed at the first communication device with recirculation through a packet processing pipeline, if applicable.

In an example, the second communication device may be in a same IGP domain as the first communication device, and the first MSD type, the first MSD value, the second MSD type, and the second MSD value may be advertised to the second communication device using an IS-IS or OSPF protocol. Alternatively, in another example, the first MSD type, the first MSD value, the second MSD type, and the second MSD value may be advertised to the SDN controller using BGP-LS or PCEP. In either case, the first MSD type, the first MSD value, the second MSD type, and the second MSD value may be advertised using an MSD sub-Type-Length-Value (TLV) as shown in FIG. 2.

Referring to FIG. 2, the MSD-Type can be a value defined in “IGP MSD-Types” registry created by Internet Assigned Numbers Authority (IANA) Considerations. IANA has created an IANA-managed registry titled “IGP MSD-Types” under the “Interior Gateway Protocol (IGP) Parameters” registry to identify MSD-Types. Types are an unsigned 8-bit number. The following values in Table 1 below are defined according to RFC 8491:

TABLE 1
MSD-Types

| Value | Name | Reference |
|---|---|---|
| 0 | Reserved | RFC 8491 |
| 1 | Base MPLS Imposition MSD | RFC 8491 |
| 2-250 | Unassigned | |
| 251-254 | Experimental Use | RFC 8491 |
| 255 | Reserved | RFC 8491 |

According to the present disclosure, a new MSD-Type, e.g., 2, can be defined for the 1 pass solution. For example, the above first MSD type may be MSD-Type 1 in Table 1 and the above second MSD type may be the newly defined MSD-Type 2.

FIG. 3 is a flowchart illustrating a method 300 according to an embodiment of the present disclosure. The method 300 can be performed at a second communication device.

At block 310, the second communication device receives, from a first communication device, a first MSD type, a first MSD value associated with the first MSD type, a second MSD type, and a second MSD value associated with the second MSD type. Here, the first MSD value indicates a maximum number of SIDs that is supported by the first communication device (for example, in the 1+ pass solution as described above), and the second MSD value indicates a maximum number of SIDs that can be imposed at the first communication device with one pass through a packet processing pipeline (for example, in the 1 pass solution as described above).

In an example, the first MSD type may be Base MPLS or SRv6 Imposition MSD. The maximum number of SIDs that is supported by the first communication device may refer to a maximum number of SIDs that can be imposed at the first communication device with recirculation through a packet processing pipeline, if applicable.

In an example, the first communication device may be in a same IGP domain as the second communication device, and the first MSD type, the first MSD value, the second MSD type, and the second MSD value may be received using an IS-IS or OSPF protocol.

In an example, the second communication device may advertise the first MSD type, the first MSD value, the second MSD type, and the second MSD value to an SDN controller using BGP-LS or PCEP.

For example, the first MSD type, the first MSD value, the second MSD type, and the second MSD value may be received from the first communication device and/or advertised to the SDN controller using an MSD sub-TLV as shown in FIG. 2. As an example, the first MSD type may be MSD-Type 1 in Table 1 above and the second MSD type may be the newly defined MSD-Type 2 as described above in connection with FIG. 1.

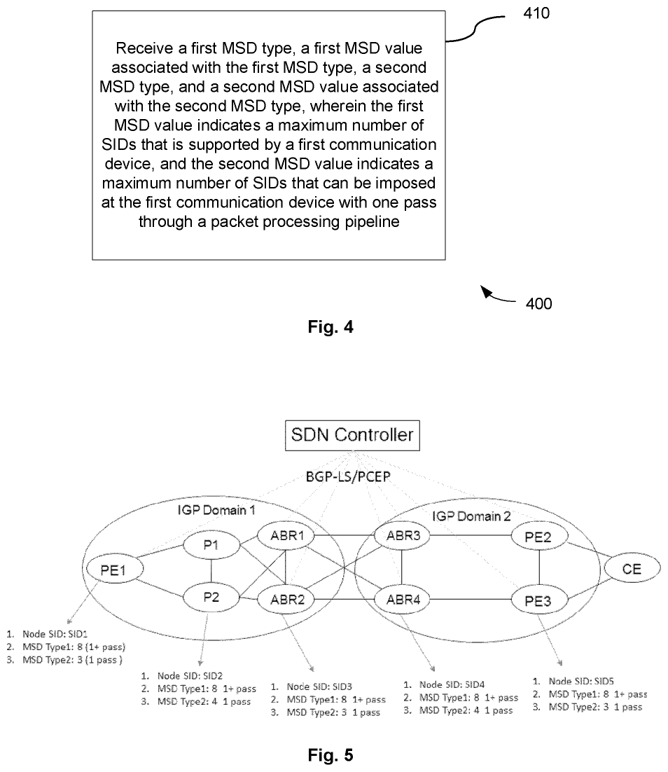

FIG. 4 is a flowchart illustrating a method 400 according to an embodiment of the present disclosure. The method 400 can be performed at an SDN controller.

At block 410, the SDN controller receives a first MSD type, a first MSD value associated with the first MSD type, a second MSD type, and a second MSD value associated with the second MSD type. Here, the first MSD value indicates a maximum number of SIDs that is supported by a first communication device (for example, in the 1+ pass solution as described above), and the second MSD value indicates a maximum number of SIDs that can be imposed at the first communication device with one pass through a packet processing pipeline (for example, in the 1 pass solution as described above).

In an example, the first MSD type, the first MSD value, the second MSD type, and the second MSD value may be received from the first communication device or a second communication device in a same IGP domain as the first communication device, using BGP-LS or PCEP. For example, the first MSD type, the first MSD value, the second MSD type, and the second MSD value may be received from using an MSD sub-TLV as shown in FIG. 2. As an example, the first MSD type may be MSD-Type 1 in Table 1 above and the second MSD type may be the newly defined MSD-Type 2 as described above in connection with FIG. 1.

In an example, the SDN controller may calculate, for a service, a path including the first communication device based on the first MSD value or the second MSD value. In particular, the path may be calculated based on the first MSD value when the service is not sensitive to latency and/or bandwidth. Alternatively, the path may be calculated based on the second MSD value when the service is sensitive to latency and/or bandwidth.

For example, the path may be calculated subject to a latency constraint and/or a bandwidth constraint. In the path calculation, when a communication device uses e.g., a two-pass solution, the latency of the communication device is considered two times higher than the latency reported by the communication device, and/or the bandwidth of the communication device is considered half the bandwidth reported by the communication device, in order to determine whether the latency constraint and/or the bandwidth constraint can be satisfied. In an example, the SDN controller may determine, based on the second MSD value, that no path including the first communication device satisfies a latency constraint and/or a bandwidth constraint for a service. When no path is found to satisfy the latency constraint and/or the bandwidth constraint, the SDN controller may generate an error report and send it to an operator.

FIG. 5 is a schematic diagram showing an example of LSP programing according to an embodiment of the present disclosure. FIG. 5 shows: an SDN controller; an IGP Domain 1 including a Provider Edge (PE) router, PE1, two Provider routers, P1 and P2, and two ABRs, ABR1 and ABR2; an IGP Domain 2 including two ABRs, ABR3 and ABR4, and two PE routers, PE2 and PE3; and a Customer Edge (CE) router.

Each node advertises its MSD types, MSD-Type 1 and MSD-Type 2, and corresponding MSD values to other nodes in the same IGP domain using ISIS or OSPF. Some nodes, e.g., ABR1-ABR4 and PE1-PE3, advertise the MSD types and corresponding MSD values to the SDN controller using BGP-LS or PCEP.

The SDN controller may have one or more specific constraints for path programing, such as end-to-end latency, bandwidth, metric, explicit path, etc. For the latency and bandwidth constraints, the SDN controller programs the path based on the MSD types and corresponding MSD values.

For a path of PE1->P2->ABR2->ABR4->PE3 for a specific service as an example, a Segment Identifier (SID), an MSD-value for MSD-Type 1, and an MSD-value for MSD-Type 2 of each node in the path are shown in FIG. 5.

If the specific service is sensitive to latency and/or bandwidth (e.g., when a node bandwidth is close to half of total bandwidth), the SDN controller may require an MSD of 3 to be the maximum number of SIDs in the SID stack at each node.

Accordingly, for the path PE1->P2->ABR2->ABR4->PE3, on PE1, the SID stack list encapsulation will be: [P2 SID2, ABR2 SID3, Service SID/label], and on ABR2, a binding segment list will be used, as: [ABR4 SID4, PE3 SIDS, Service SID/label].

Alternatively, if the specific service is not sensitive to latency and/or bandwidth, the SDN controller may have an MSD of 5 to be the maximum number of SIDs in the SID stack at each node. Accordingly, for the path PE1->P2->ABR2->ABR4->PE3, on PE1, the SID stack list encapsulation will be: [P2 SID2, ABR2 SID3, ABR4 SID4, PE3 SIDS, Service SID/label].

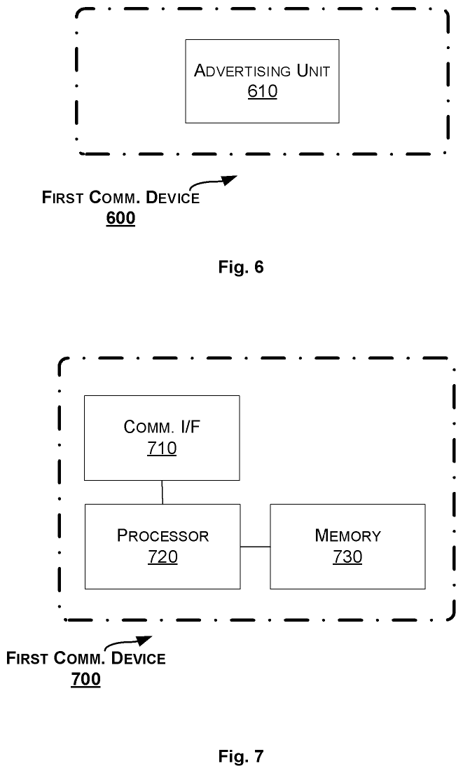

Correspondingly to the method 100 as described above, a first communication device is provided. FIG. 6 is a block diagram of a first communication device 600 according to an embodiment of the present disclosure.

The first communication device 600 is operative to perform the method 100 as described above in connection with FIG. 1. The first communication device 600 includes an advertising unit 610 configured to advertise, to a second communication device or an SDN controller, a first MSD type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base MPLS or SRv6 Imposition MSD.

In an embodiment, the second communication device may be in a same IGP domain as the first communication device, and the first MSD type, the first MSD value, the second MSD type, and the second MSD value may be advertised to the second communication device using an IS-IS or OSPF protocol.

In an embodiment, the first MSD type, the first MSD value, the second MSD type, and the second MSD value may be advertised to the SDN controller using BGP-LS or PCEP.

The unit 610 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1.

FIG. 7 is a block diagram of a first communication device 700 according to another embodiment of the present disclosure.

The first communication device 700 includes a communication interface 710, a processor 720 and a memory 730. The memory 730 contains instructions executable by the processor 720 whereby the first communication device 700 is operative to perform the actions, e.g., of the procedure described earlier in conjunction with FIG. 1. Particularly, the memory 730 contains instructions executable by the processor 720 whereby the first communication device 700 is operative to: advertise, to a second communication device or an SDN controller, a first MSD type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base MPLS or SRv6 Imposition MSD.

In an embodiment, the second communication device may be in a same IGP domain as the first communication device, and the first MSD type, the first MSD value, the second MSD type, and the second MSD value may be advertised to the second communication device using an IS-IS or OSPF protocol.

In an embodiment, the first MSD type, the first MSD value, the second MSD type, and the second MSD value may be advertised to the SDN controller using BGP-LS or PCEP.

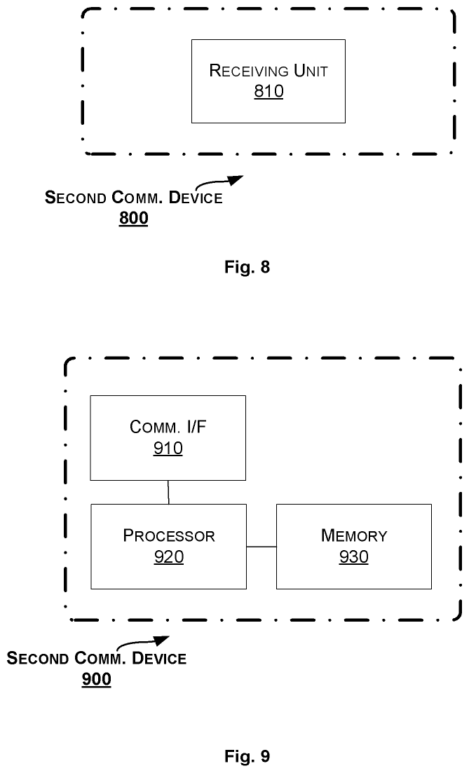

Correspondingly to the method 300 as described above, a second communication device is provided. FIG. 8 is a block diagram of a second communication device 800 according to an embodiment of the present disclosure.

The second communication device 800 is operative to perform the method 300 as described above in connection with FIG. 3. The second communication device 800 includes a receiving unit 810 configured to receive, from a first communication device, a first MSD, type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base MPLS or SRv6 Imposition MSD.

In an embodiment, the first communication device may be in a same IGP domain as the second communication device, and the first MSD type, the first MSD value, the second MSD type, and the second MSD value may be received using an IS-IS or OSPF protocol.

In an embodiment, the second communication device 800 may further include: an advertising unit configured to advertise the first MSD type, the first MSD value, the second MSD type, and the second MSD value to an SDN controller using BGP-LS or PCEP.

The unit 810 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

FIG. 9 is a block diagram of a second communication device 900 according to another embodiment of the present disclosure.

The second communication device 900 includes a communication interface 910, a processor 920 and a memory 930. The memory 930 contains instructions executable by the processor 920 whereby the second communication device 900 is operative to perform the actions, e.g., of the procedure described earlier in conjunction with FIG. 3. Particularly, the memory 930 contains instructions executable by the processor 920 whereby the second communication device 900 is operative to: receive, from a first communication device, a first MSD, type, a first MSD value associated with the first MSD type, a second MSD type, and a second MSD value associated with the second MSD type. The first MSD value indicates a maximum number of SIDs that is supported by the first communication device, and the second MSD value indicates a maximum number of SIDs that can be imposed at the first communication device with one pass through a packet processing pipeline.

In an embodiment, the first MSD type may be Base MPLS or SRv6 Imposition MSD.

In an embodiment, the first communication device may be in a same IGP domain as the second communication device, and the first MSD type, the first MSD value, the second MSD type, and the second MSD value may be received using an IS-IS or OSPF protocol.

In an embodiment, the memory 930 may further contain instructions executable by the processor 920 whereby the second communication device 900 is operative to: advertise the first MSD type, the first MSD value, the second MSD type, and the second MSD value to an SDN controller using BGP-LS or PCEP.

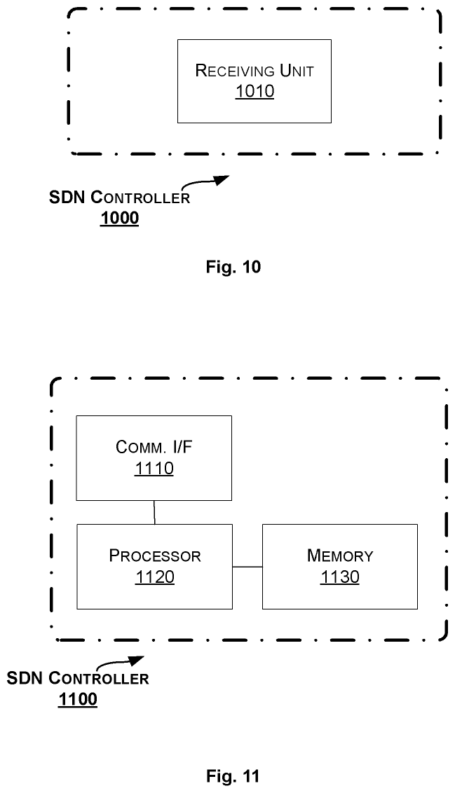

Correspondingly to the method 400 as described above, an SDN controller is provided. FIG. 10 is a block diagram of an SDN controller 1000 according to an embodiment of the present disclosure.

The SDN controller 1000 is operative to perform the method 400 as described above in connection with FIG. 4. The SDN controller 1000 includes a receiving unit 1010 configured to receive a first MSD type, a first MSD value associated with the first MSD type, a second MSD type, and a second MSD value associated with the second MSD type. The first MSD value indicates a maximum number of SIDs that is supported by a first communication device, and the second MSD value indicates a maximum number of SIDs that can be imposed at the first communication device with one pass through a packet processing pipeline.

In an embodiment, the first MSD type, the first MSD value, the second MSD type, and the second MSD value may be received from the first communication device or a second communication device in a same IGP domain as the first communication device, using BGP-LS or PCEP.

In an embodiment, the SDN controller 1000 may further include: a calculating unit configured to calculate, for a service, a path including the first communication device based on the first MSD value or the second MSD value.

In an embodiment, the path may be calculated based on the first MSD value when the service is not sensitive to latency and/or bandwidth.

In an embodiment, the path may be calculated based on the second MSD value when the service is sensitive to latency and/or bandwidth.

In an embodiment, the path may be calculated subject to a latency constraint and/or a bandwidth constraint.

In an embodiment, the SDN controller 1000 may further include: a determining unit configured to determine, based on the second MSD value, that no path including the first communication device satisfies a latency constraint and/or a bandwidth constraint for a service.

In an embodiment, the SDN controller 1000 may further include: a generating unit configured to generate an error report when no path is found to satisfy the latency constraint and/or the bandwidth constraint.

The unit 1010 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

FIG. 11 is a block diagram of an SDN controller 1100 according to another embodiment of the present disclosure.

The SDN controller 1100 includes a communication interface 1110, a processor 1120 and a memory 1130. The memory 1130 contains instructions executable by the processor 1120 whereby the SDN controller 1100 is operative to perform the actions, e.g., of the procedure described earlier in conjunction with FIG. 4. Particularly, the memory 1130 contains instructions executable by the processor 1120 whereby the SDN controller 1100 is operative to: receive a first MSD type, a first MSD value associated with the first MSD type, a second MSD type, and a second MSD value associated with the second MSD type. The first MSD value indicates a maximum number of SIDs that is supported by a first communication device, and the second MSD value indicates a maximum number of SIDs that can be imposed at the first communication device with one pass through a packet processing pipeline.

In an embodiment, the first MSD type, the first MSD value, the second MSD type, and the second MSD value may be received from the first communication device or a second communication device in a same IGP domain as the first communication device, using BGP-LS or PCEP.

In an embodiment, the memory 1130 may further contain instructions executable by the processor 1120 whereby the SDN controller 1100 is operative to: calculate, for a service, a path including the first communication device based on the first MSD value or the second MSD value.

In an embodiment, the path may be calculated based on the first MSD value when the service is not sensitive to latency and/or bandwidth.

In an embodiment, the path may be calculated based on the second MSD value when the service is sensitive to latency and/or bandwidth.

In an embodiment, the path may be calculated subject to a latency constraint and/or a bandwidth constraint.

In an embodiment, the memory 1130 may further contain instructions executable by the processor 1120 whereby the SDN controller 1100 is operative to: determine, based on the second MSD value, that no path including the first communication device satisfies a latency constraint and/or a bandwidth constraint for a service.

In an embodiment, the memory 1130 may further contain instructions executable by the processor 1120 whereby the SDN controller 1100 is operative to: generate an error report when no path is found to satisfy the latency constraint and/or the bandwidth constraint.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 720 causes the first communication device 700 to perform the actions, e.g., of the procedure described earlier in conjunction with FIG. 1; or code/computer readable instructions, which when executed by the processor 920 causes the second communication device 900 to perform the actions, e.g., of the procedure described earlier in conjunction with FIG. 3; or code/computer readable instructions, which when executed by the processor 1120 causes the SDN controller 1100 to perform the actions, e.g., of the procedure described earlier in conjunction with FIG. 4.

The computer program product may be configured as a computer program code structured in computer program modules. The computer program modules could essentially perform the actions of the flow illustrated in FIG. 1, 3, or 4.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a first communication device, comprising:
advertising, to a second communication device or a Software Defined Networking, SDN, controller, a first Maximum Segment Identifier ‘SID’ Depth, MSD, type, a first MSD value associated with the first MSD type, a second MSD type, and a second MSD value associated with the second MSD type, the first MSD value indicating a maximum number of SIDs that is supported by the first communication device, and the second MSD value indicating a maximum number of SIDs that can be imposed at the first communication device with one pass through a packet processing pipeline.

2. The method of claim 1, wherein the first MSD type is Base Multi-Protocol Label Switching, MPLS, or Segment Routing over Internet Protocol version 6 ‘IPv6’, SRv6, Imposition MSD.

3. The method of claim 1, wherein the second communication device is in a same Interior Gateway Protocol, IGP, domain as the first communication device, and the first MSD type, the first MSD value, the second MSD type, and the second MSD value are advertised to the second communication device using an Intermediate System to Intermediate System, IS-IS, or Open Shortest Path First, OSPF, protocol.

4. The method of claim 1, wherein the first MSD type, the first MSD value, the second MSD type, and the second MSD value are advertised to the SDN controller using Border Gateway Protocol-Link State, BGP-LS, or Path Computation Element Protocol, PCEP.

5. A method in a second communication device or a Software Defined Networking, SDN, controller, the method comprising:
receiving, from a first communication device, a first Maximum Segment Identifier ‘SID’ Depth, MSD, type, a first MSD value associated with the first MSD type, a second MSD type, and a second MSD value associated with the second MSD type, the first MSD value indicating a maximum number of SIDs that is supported by the first communication device, and the second MSD value indicating a maximum number of SIDs that can be imposed at the first communication device with one pass through a packet processing pipeline.

6. The method of claim 5, wherein the first MSD type is Base Multi-Protocol Label Switching, MPLS, or Segment Routing over Internet Protocol version 6 ‘IPv6’, SRv6, Imposition MSD.

7. The method of claim 5, wherein the first communication device is in a same Interior Gateway Protocol, IGP, domain as the second communication device, and the first MSD type, the first MSD value, the second MSD type, and the second MSD value are received using an Intermediate System to Intermediate System, IS-IS, or Open Shortest Path First, OSPF, protocol.

8. The method of claim 5, further comprising:
advertising the first MSD type, the first MSD value, the second MSD type, and the second MSD value to a Software Defined Networking, SDN, controller using Border Gateway Protocol-Link State, BGP-LS, or Path Computation Element Protocol, PCEP.

9.-16. (canceled)

17. A first communication device, comprising a communication interface, a processor and a memory, the memory comprising instructions executable by the processor to configure the first communication device to:
advertise, to a second communication device or a Software Defined Networking, SDN, controller, a first Maximum Segment Identifier ‘SID’ Depth, MSD, type, a first MSD value associated with the first MSD type, a second MSD type, and a second MSD value associated with the second MSD type, the first MSD value indicating a maximum number of SIDs that is supported by the first communication device, and the second MSD value indicating a maximum number of SIDs that can be imposed at the first communication device with one pass through a packet processing pipeline.

18. A second communication device or a Software Defined, SDN, controller, comprising a communication interface, a processor and a memory, the memory comprising instructions executable by the processor whereby the second communication device or the SDN controller is configured to:
receive, from a first communication device, a first Maximum Segment Identifier ‘SID’ Depth, MSD, type, a first MSD value associated with the first MSD type, a second MSD type, and a second MSD value associated with the second MSD type, the first MSD value indicating a maximum number of SIDs that is supported by the first communication device, and the second MSD value indicating a maximum number of SIDs that can be imposed at the first communication device with one pass through a packet processing pipeline.

19. (canceled)

20. (canceled)

21. The method of claim 2, wherein the second communication device is in a same Interior Gateway Protocol, IGP, domain as the first communication device, and the first MSD type, the first MSD value, the second MSD type, and the second MSD value are advertised to the second communication device using an Intermediate System to Intermediate System, IS-IS, or Open Shortest Path First, OSPF, protocol.

22. The method of claim 2, wherein the first MSD type, the first MSD value, the second MSD type, and the second MSD value are advertised to the SDN controller using Border Gateway Protocol-Link State, BGP-LS, or Path Computation Element Protocol, PCEP.

23. The first communication device of claim 17, wherein the first MSD type is Base Multi-Protocol Label Switching, MPLS, or Segment Routing over Internet Protocol version 6 ‘IPv6’, SRv6, Imposition MSD.

24. The first communication device of claim 17, wherein the second communication device is in a same Interior Gateway Protocol, IGP, domain as the first communication device, and the first MSD type, the first MSD value, the second MSD type, and the second MSD value are advertised to the second communication device using an Intermediate System to Intermediate System, IS-IS, or Open Shortest Path First, OSPF, protocol.

25. The first communication device of claim 17, wherein the first MSD type, the first MSD value, the second MSD type, and the second MSD value are advertised to the SDN controller using Border Gateway Protocol-Link State, BGP-LS, or Path Computation Element Protocol, PCEP.

26. The method of claim 6, wherein the first communication device is in a same Interior Gateway Protocol, IGP, domain as the second communication device, and the first MSD type, the first MSD value, the second MSD type, and the second MSD value are received using an Intermediate System to Intermediate System, IS-IS, or Open Shortest Path First, OSPF, protocol.

27. The method of claim 6, further comprising:
advertising the first MSD type, the first MSD value, the second MSD type, and the second MSD value to a Software Defined Networking, SDN, controller using Border Gateway Protocol-Link State, BGP-LS, or Path Computation Element Protocol, PCEP.

28. The second communication device or SDN controller of claim 18, wherein the first MSD type is Base Multi-Protocol Label Switching, MPLS, or Segment Routing over Internet Protocol version 6 ‘IPv6’, SRv6, Imposition MSD.

29. The second communication device or SDN controller of claim 18, wherein the first communication device is in a same Interior Gateway Protocol, IGP, domain as the second communication device, and the first MSD type, the first MSD value, the second MSD type, and the second MSD value are received using an Intermediate System to Intermediate System, IS-IS, or Open Shortest Path First, OSPF, protocol.

30. The second communication device or SDN controller of claim 18, wherein the second communication device or SDN controller is further configured to:
advertise the first MSD type, the first MSD value, the second MSD type, and the second MSD value to a Software Defined Networking, SDN, controller using Border Gateway Protocol-Link State, BGP-LS, or Path Computation Element Protocol, PCEP.
